(19) United States
(12) Patent Application Publication
(10) Pub. No.: US 2009/0014382 A1
(43) Pub. Date: Jan. 15, 2009

(54) Filtration faucet system

(76) Inventors: David C. Kwan, Monterey Park, CA (US); Teri Q. Kwan, Monterey Park, CA (US)

Correspondence Address: DAVID AND RAYMOND PATENT FIRM, 108 N. YNEZ AVE., SUITE 128, MONTEREY PARK, CA, 91754, US

(21) Appl. No.: 11/827,733

(22) Filed: Jul. 13, 2007

(51) Int. Cl. B01D 35/02; B01D 27/08

(52) U.S. Cl. 210/433.1

(57) ABSTRACT

A filtration faucet system includes a filter housing for mounting underneath a faucet countertop and a filter cartridge. The filter housing has a filter compartment, a water inlet adapted for operatively linking to a water source, a filtered water outlet adapted for operatively linking to a first water opening of a faucet device, and an unfiltered water outlet adapted for operatively linking to a second water opening of the faucet device. The filter cartridge is supported in the filter compartment and is adapted not only for filtering water flowing from the water inlet to the filtered water outlet before the water exits at the first water opening but also for guiding the water directly flowing from the water inlet to the unfiltered water outlet before the water exits at the second water opening.

### BACKGROUND OF THE PRESENT INVENTION

1. Field of Invention

The present invention relates to a filtration faucet system and more particularly to water filter with flexible installation and large quantity of water supply.

2. Description of Related Arts

People already paid much attention to the quality of drinking water because it affects our health directly. As a result, water filters for drinking are well developed. These filters are generally mounted over one faucet in the kitchen, and people can select original water for regular using or filtered water for drinking by an extra faucet or a diverter valve. This costs extra devices, and limits the dimension of the filter and the amount of filtered water.

Recent research shows that not only the drinking water but the water we are using for other purposes in our daily life can also directly or indirectly affect our health. For example, if water used in bathing carries some chemicals, during the bath, chemicals can deposit onto people's skin directly, some chemicals will also evaporate into the air at high temperature and be breathed by people. It is believed that water used in such as bath, food cleaning, and laundry are also need purified. This will consume a large quantity of filtered water. While currently used water filters are generally mounted under a single faucet, for example, in the kitchen. It occupied a lot of space over the sink. If other room such as bathroom needs purified water, then extra faucet and plumb is required, and also cost a lot of labor effort. Further more, because the filter's dimension is limited, the filtering flow can not fulfill the increasing requirement of the purified water.

### SUMMARY OF THE PRESENT INVENTION

A major object of the present invention is to provide purified water for a faucet device.

Another object of the present invention is to provide a filtration faucet system which is convenient to be installed in different locations.

Another object of the present invention is to provide a filtration faucet system which provides large quantity of purified water.

Accordingly, in order to accomplish above objects, the present invention provides a filtration faucet system for a faucet device having first and second water openings in selectively controllable manner, comprising:

a filter housing, which is adapted for mounting underneath a faucet countertop, having a filter compartment, a water inlet adapted for operatively linking to a water source, a filtered water outlet adapted for operatively linking to the first water opening of the faucet device, and an unfiltered water outlet adapted for operatively linking to the second water opening of the faucet device; and

a filter cartridge supported in the filter compartment of the filter housing, wherein the filter cartridge is adapted not only for filtering water flowing from the water inlet to the filtered water outlet before the water exits at the first water opening but also for guiding the water directly flowing from the water inlet to the unfiltered water outlet before the water exits at the second water opening, such that the filter cartridge is adapted for selectively filtering and unfiltering the water to the faucet device.

These and other objectives, features, and advantages of the present invention will become apparent from the following detailed description, the accompanying drawings, and the appended claims.

### BRIEF DESCRIPTION OF THE DRAWINGS

FIG. 1 is a perspective view of the filtration faucet system according to a preferred embodiment of the present invention.

FIG. 2 is a section view of the filtration faucet system according to the above preferred embodiment the present invention.

FIG. 3 is a perspective view of the filtration faucet system the cap detached.

FIG. 4 is a schematic of the filtration faucet system connected with two faucets under a sink according to the above preferred embodiment the present invention.

FIG. 5 is a perspective view of the filtration faucet system according to the above preferred embodiment the present invention, illustrates the filtered water outlet and the unfiltered water outlet connecting with a faucet through a diverter valve.

FIG. 6 is a perspective view of a filtration faucet system according to a second preferred embodiment of the present invention.

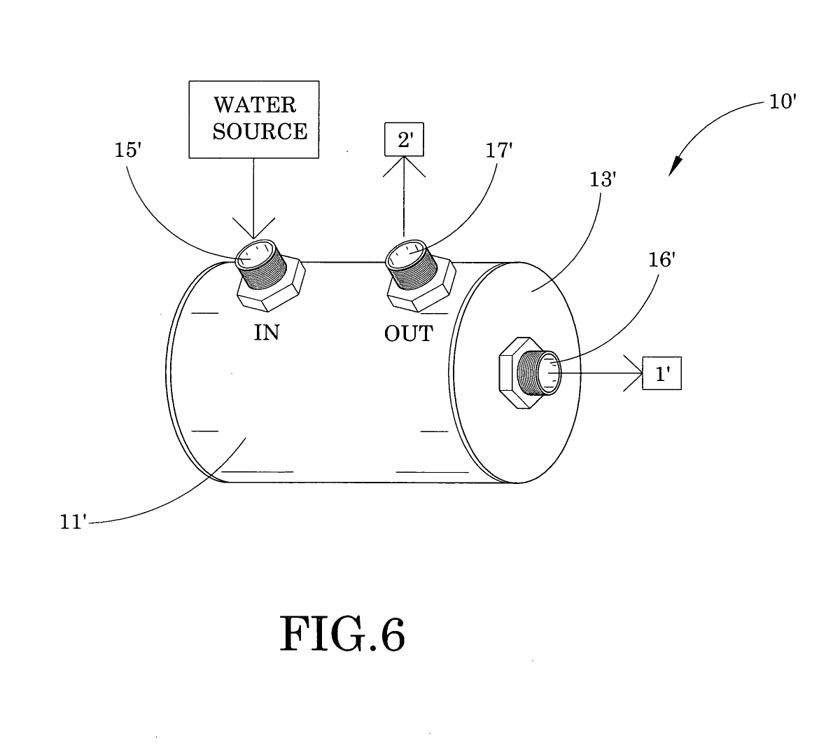

FIG. 7 is a sectional view of the filtration faucet system according to the above second preferred embodiment the present invention.

FIG. 8 is an exploded perspective view of the filtration faucet system according to the above second preferred embodiment of the present invention.

FIG. 9 illustrates the filtration faucet system mounted to a faucet according to the above second preferred embodiment of the present invention.

### DETAILED DESCRIPTION OF THE PREFERRED EMBODIMENT

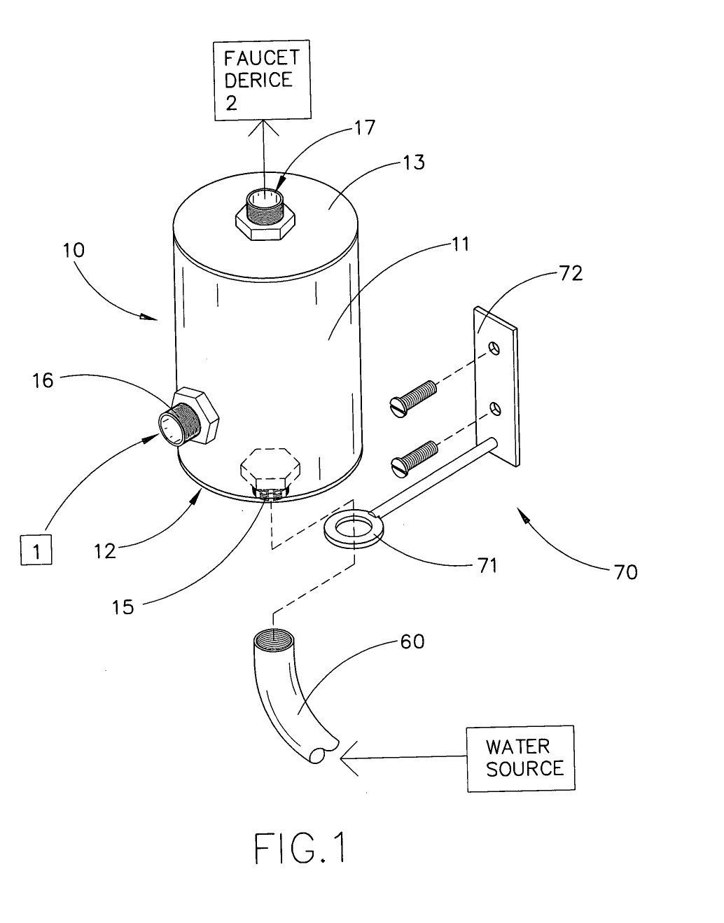

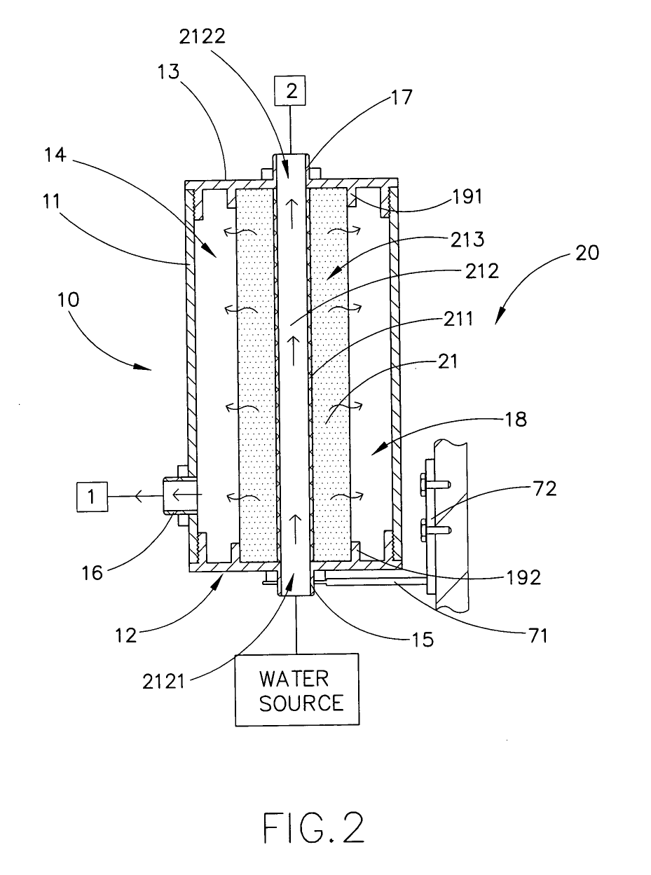

Referring to FIGS. 1 and 2 of the drawings, a filtration faucet system according to a preferred embodiment of the present invention is illustrated, wherein the filtration faucet system is adapted to operatively couple with a faucet device having first and second water openings 1, 2 in a selectively controllable manner. According to the preferred embodiment, the filtration faucet system comprises a filter housing 10 and a filter cartridge 20.

The filter housing 10, which is adapted for mounting underneath a faucet countertop, has a filter compartment 14, a water inlet 15 adapted for operatively linking to a water source, a filtered water outlet 16 adapted for operatively linking to the first water opening 1 of the faucet device, and an unfiltered water outlet 17 adapted for operatively linking to the second water opening 2 of the faucet device.

The filter cartridge 20 is supported in the filter compartment 14 of the filter housing 10, wherein the filter cartridge 20 is adapted not only for filtering water flowing from the water inlet 15 to the filtered water outlet 16 before the water exits at the first water opening 1 but also for guiding the water directly flowing from the water inlet 15 to the unfiltered water outlet 17 before the water exits at the second water opening 2, such that the filter cartridge 20 is adapted for selectively filtering and unfiltering the water to the faucet device.

According to the preferred embodiment, the filter housing 10 has a cylindrical shape. The filter housing 10 comprises a surrounding wall 11 supporting the filtered water outlet 16 thereat, a top wall 13 supporting the unfiltered water outlet 17 thereat, and a bottom wall 12 supporting the water inlet 15 thereat, wherein the filter compartment 14 is defined within the filter surrounding wall 11, the top wall 13 and the bottom wall 12. In other words, the filtered water outlet 16, the unfiltered water outlet 17, and the water inlet 15 are formed at the surrounding wall 11, the top wall 13 and the bottom wall 12 of the filter housing 10 respectively. Therefore, when the water upwardly flows from the water source into the filter compartment 14 via the water inlet 15, the water will either upwardly flow to the unfiltered water outlet 17 or radially flow to the filtered water outlet 16 through the filter cartridge 20.

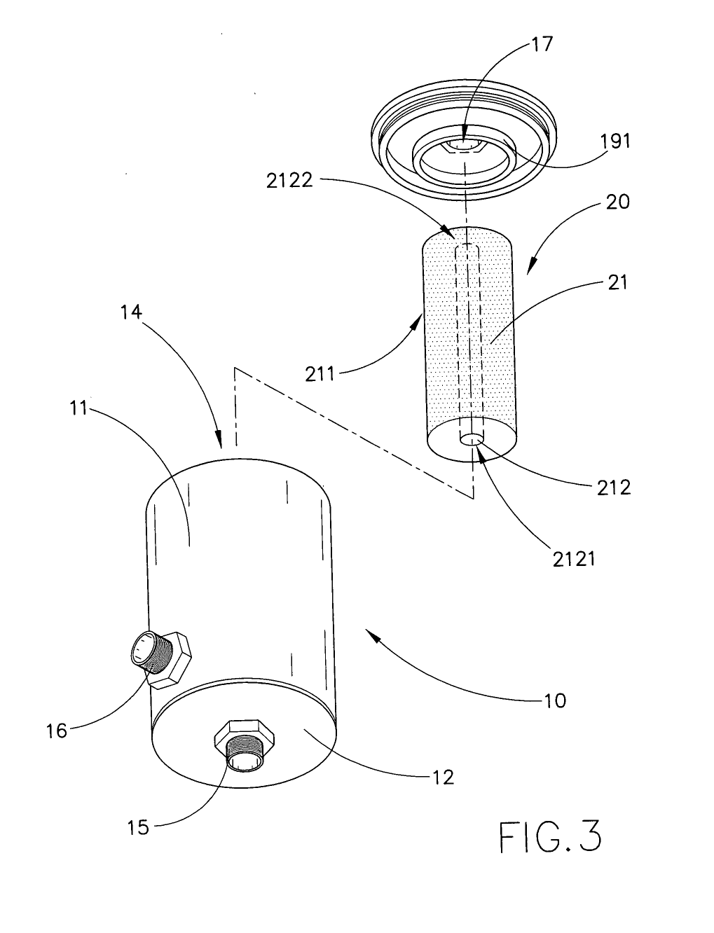

As shown in FIGS. 2 and 3, the top wall 13 of the filter housing 10 is detachably coupled with the surrounding wall 11 for allowing the filter cartridge 20 being replaceable supported in the filter housing 10. Therefore, the top wall 13 of the filter housing 10 forms a detachable cap having an outer threaded portion to detachably couple with an inner threaded portion of the surrounding wall 11. In other words, the filter housing 10 can be opened by detaching the top wall 13, so that the filter cartridge 20 can be replaced and the filter compartment 14 can be cleaned.

As shown in FIG. 1, the filtration faucet system further comprises a flexible water pipe 60 for selectively adjusting a position of the filter housing 10 with respect to the water source, wherein the flexible water pipe 60 has a first end detachably coupling with the water inlet 15 of the filter housing 10 and a second end adapted for detachably coupling with the water source to guide the water to flow from the water source to the filter housing 10. It is worth to mention that since the filtration faucet system is mounted underneath the faucet countertop, the flexible water pipe 60 allows the filter housing 10 to be selectively adjusted the distance between the water inlet 15 and the water source.

In addition, the filtration faucet system further comprises a wall mount support 70 for supporting the filter housing 10 in position, wherein the wall mount support 70, having a L-shaped structure, has a longitudinal mounting ring 71 detachably mounting to the water inlet 15 of the filter housing 10 and a transverse wall panel 72 adapted for securely affixing to a wall under the faucet countertop to substantially the filter housing 10 underneath the faucet countertop. In other words, the wall mount support 70 is adapted to securely mount the filter housing 10 under the faucet countertop in a suspended manner.

The filter cartridge 20 comprises a filter core 21 having a water passage 212 extended from the water inlet 15 to the unfiltered water outlet 17 for guiding the water passing from the water source to the second water opening 2 in an unfiltered manner, and a filtering chamber 18 communicating with the filtered water outlet 16 and defining between an inner wall of the filter compartment 14 and the filter core 21 for filtering the water when the water passes through the filter core 21.

Accordingly, the water passage 212 has a water entrance 2121 operatively linked to the water inlet 15 of the filter housing 10 and a water exit 2122 which is operatively linked to the unfiltered water outlet 17 and is arranged in such a manner that when the water exit 2122 is closed for blocking the water passing therethrough, the water is guided to pass through the filter core 21 to the filtering chamber 18, when the water exit 2122 is opened for allowing the water passing therethrough, the water is guided to flow to the unfiltered water outlet 17.

The filter core 21, having an elongated tubular structure, comprises a tubular filtering wall 211 defining the water passage 212 therewithin and filtering elements 213 provided at the filtering wall 211 such that when the water passes through the filtering wall 211, the water is filtered via the filtering elements 213 to the filter chamber 18 before exiting at the filtered water outlet 16. Accordingly, the filtering elements 213 are activated carbon and/or reverse osmosis membrane for filtering the unwanted substances in the water.

It is worth to mention that the filter core 21 should have a length corresponding to a height of the filter housing 10 such that the filter core 21 is fittingly supported in the filter housing 10. In addition, a diameter of the filter core 21 should be smaller that a diameter of the filter housing 10 to define the water passage 212 within an inner circumferential wall of the filter core 21 and the filtering chamber 18 between the inner wall of the filter compartment 14 and the outer circumferential wall of the filter core 21.

As shown in FIG. 2, the filter housing 10 further comprises a cartridge holder for retaining the filter cartridge 20 in position, wherein the cartridge holder comprises a first cartridge seat 191 provided at the top wall 13 and a second cartridge seat 192 which is provided at the bottom wall 12 and is coaxially aligned with the first cartridge seat 191. Accordingly, two ends of the filter core 21 is seated at the first and second cartridge seats 191, 192 respectively to alignedly support the filter core 21 in the filter compartment 14.

It is worth to mention that each of the first and second cartridge seats 191, 192 has a ring-shaped structure to fittingly encircle the respective end of the filter core 21 such that the filter core 21 is longitudinally supported within the filter housing along the center of the filter housing 10.

As shown in FIG. 2, the water inlet 15 is coaxially aligned with the unfiltered water outlet 17 for guiding the water to directly flow from the water source to the second opening 2 of the faucet device. The water inlet 15 is coaxially aligned with the second cartridge seat 192 while the unfiltered water outlet 17 is coaxially aligned with the first cartridge seat. 191. Therefore, when the filter core 21 is held by the first and second cartridge seats 191, 192, the water entrance 2121 and the water exit 2122 of the water passage 212 are automatically aligned with the water inlet 15 and the unfiltered water outlet 17 respectively. It is worth to mention that since the unfiltered water outlet 17 is coaxially aligned with the water inlet 15, the water can directly flow from the water source to the second water opening 2 of the faucet device in responsive to the original flow rate of the water.

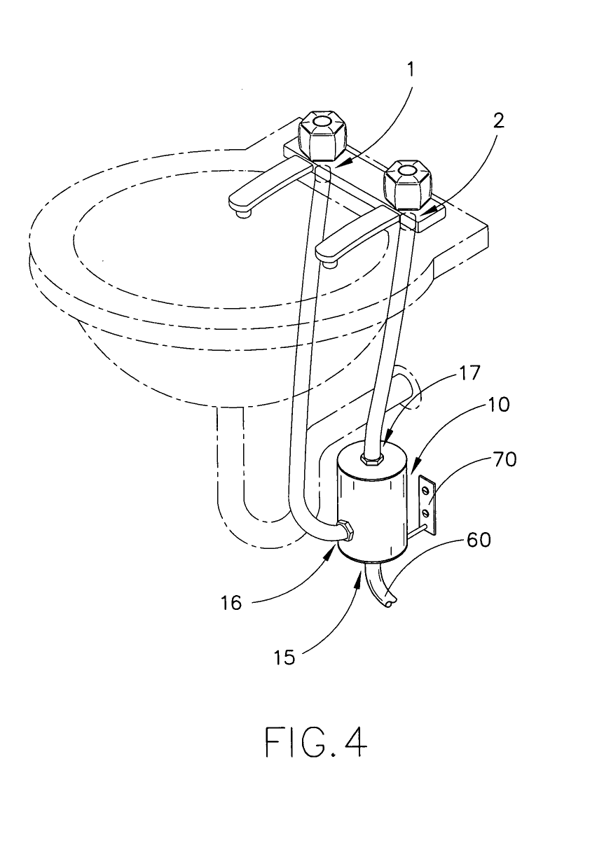

The present invention is compatible to existing water supply system via the water pipes. It is very convenient to place the filtration faucet system within limited room such as a kitchen or a bathroom. As illustrated in FIG. 4, in a preferred embodiment, the filtration faucet system is connected with a water source with the flexible water pipe 60. The filtration faucet system is located under a sink. The water inlet 15 is coupled with the water supply pipe to the water source. The unfiltered water outlet 17 and the filtered water outlet 16 are coupled with the two original faucets of the sink through two pieces of pipe respectively. Therefore, the second water opening 2 of the second faucet is connected with the unfiltered water outlet 17 to control the output of unfiltered water while the first water opening 1 of the first faucet is connected with the filtered water outlet 16 to control the output of filtered water. In other words, when the switch of the first faucet is actuated to open the first water opening 1, i.e. the water exit 2122 is closed, the water is firstly filtered and is guided to flow to the first faucet. When the switch of the second faucet is actuated to open the second water opening 2, i.e. the water exit 2122 is opened, the water is directly guided to flow from the water source to the second faucet without filtering the water.

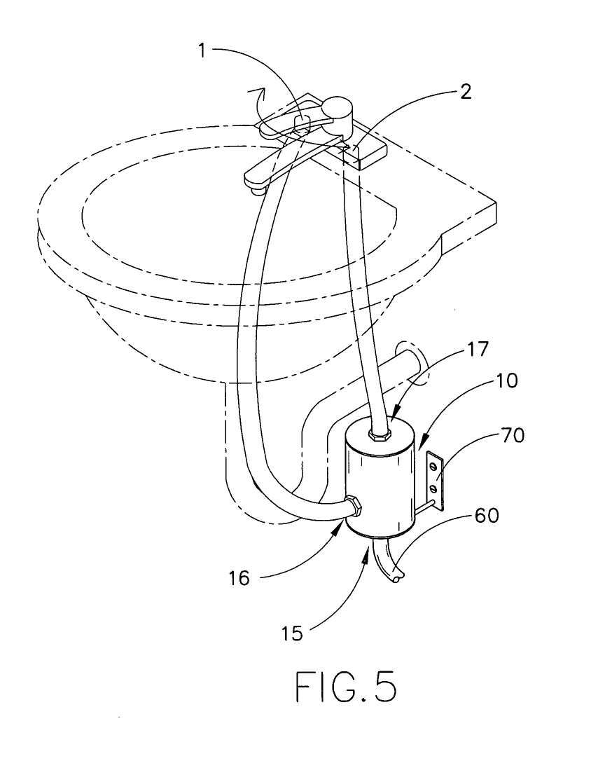

Alternatively, the filtration faucet system of the present invention can be operatively connected to a single faucet as shown in FIG. 5. Accordingly, the faucet has a switch to control the first and second water openings 1, 2 in an opened/closed manner. In other words, when the switch is actuated to open the first water opening 1 while the second water opening 2 is remained at the closed manner, the water is firstly filtered and is guided to flow to the faucet. When the switch is actuated to open the second water opening 2 while the first water opening 1 is remained at the closed manner, the water is directly guided to flow from the water source to the faucet without filtering the water.

In this embodiment, the filtration faucet system is hidden under the sink. Comparing to traditional filters which are installed over the sink and occupy a lot of working space, this installation doesn't occupy any working space when people are using the faucets. Installing under the sink also avoids affecting the outlook of the room. No extra decoration is needed for the decoration of the room and the filtration faucet system which saves the cost. Also, no extra faucet or valve is needed. The filtration faucet system is flexibly coupled with the existing faucet system without extra effort and devices.

The dimension and weight of the embodiment of the present invention is not limited. The filters installed under faucets are limited by the size and weight because the working space under the faucets is small, and faucets can't support heavy objects. In this embodiment, the filtration faucet system is installed under the sink having relatively much larger space therein, so the dimension of the filter is big, consequently, the amount of the water can be filtered in unit time is large. Further more, the filtration faucet system is supported by the ground and the wall. Therefore the system can be heavily loaded with large amount of water, fabricated with heavy but enduring materials, for example, stainless steel. Referring to FIG. 4, the filtration faucet system is mounted on the wall by the wall mount support 70.

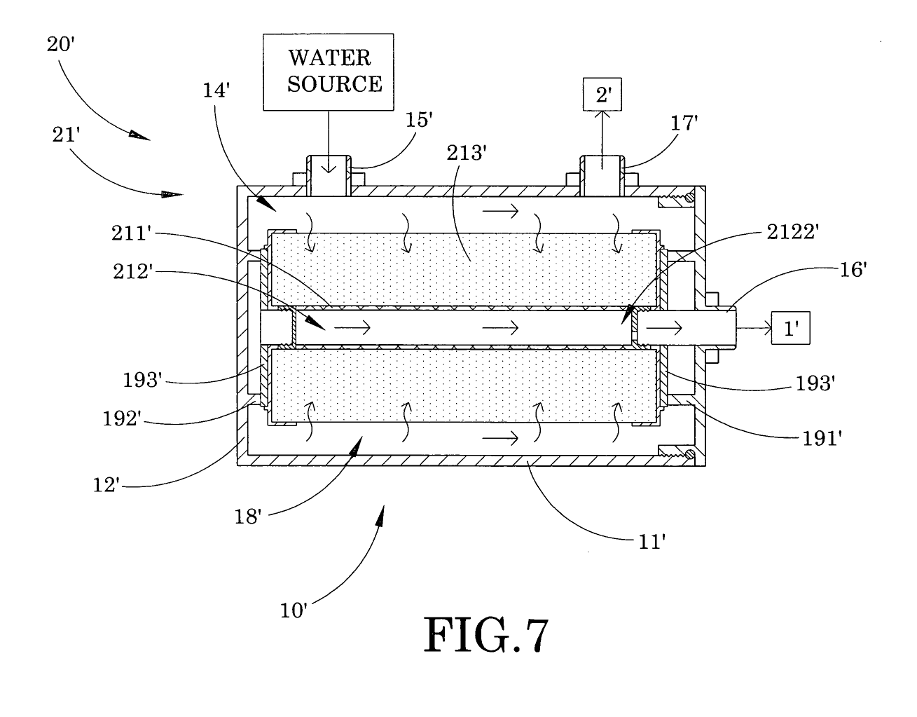

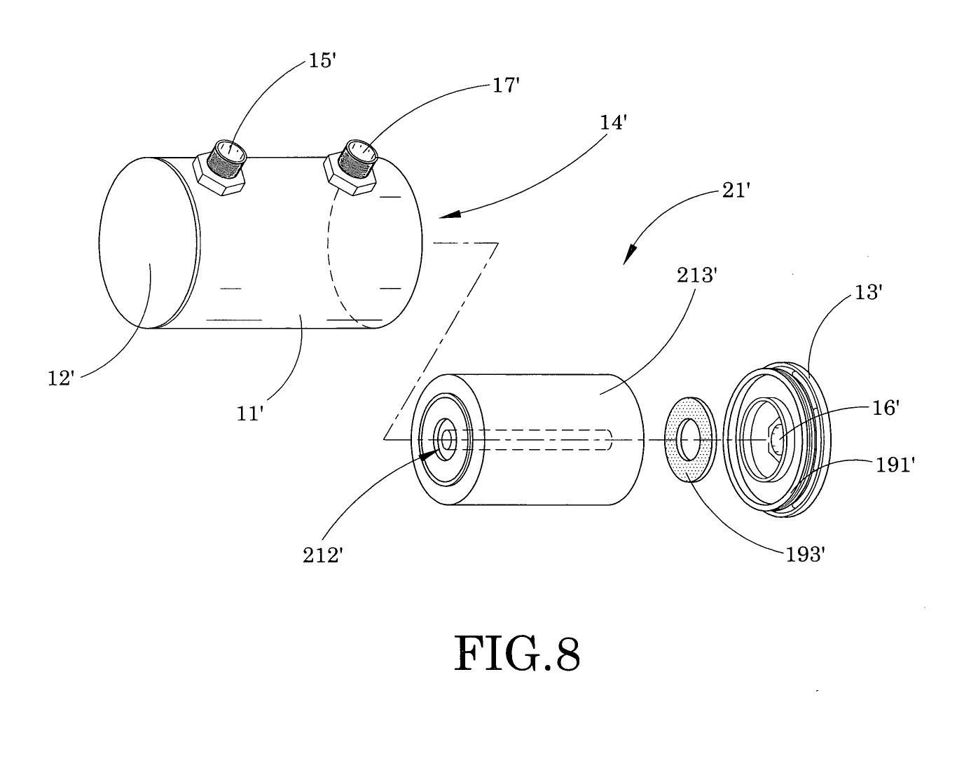

As shown in FIGS. 7 and 8, a filtration faucet system of a second embodiment illustrates a first alternative mode of the first embodiment of the present invention, wherein the filtration faucet system comprises a filter housing 10′ and a filter cartridge 20′.

The filter housing 10, which is adapted for mounting underneath a faucet countertop, has a filter compartment 14′, a water inlet 15′ adapted for operatively linking to a water source, a filtered water outlet 16′ adapted for operatively linking to the first water opening 1′ of the faucet device, and an unfiltered water outlet 17′ adapted for operatively linking to the second water opening 2′ of the faucet device.

The filter cartridge 20′ is supported in the filter compartment 14′ of the filter housing 10′, wherein the filter cartridge 20′ is adapted not only for filtering water flowing from the water inlet 15′ to the filtered water outlet 16′ before the water exits at the first water opening 1′ but also for guiding the water directly flowing from the water inlet 15′ to the unfiltered water outlet 17′ before the water exits at the second water opening 2′, such that the filter cartridge 20′ is adapted for selectively filtering and unfiltering the water to the faucet device.

According to the preferred embodiment, the filter housing 10′ has a cylindrical shape. The filter housing 10′ comprises a surrounding wall 11′ supporting the water inlet 15′ and the unfiltered water outlet 17′ in a spaced apart manner, a first side wall 13′ supporting the filtered water outlet 16′ thereat, and an opposed second side wall 12′. Accordingly, the water inlet 15′ and the unfiltered water outlet 17′ are positioned at the same orientation. Therefore, when the water flows from the water source into the filter compartment 14′ via the water inlet 15′, the water will either flow to the unfiltered water outlet 17′ or flow to the filtered water outlet 16′ through the filter cartridge 20′. It is worth to mention that the water inlet 15′ is provided at the surrounding wall 11′ at a position close to the second side wall 12′ while the unfiltered water outlet 17′ is provided at the surrounding wall 11′ at a position close to the first side wall 13′. Therefore, the water will take longer path to flow from the water inlet 15′ to the filtered water outlet 16′ and the unfiltered water outlet 17′, especially the water being filtered by the filter cartridge 20′ before exiting the filtered water outlet 16′.

As shown in FIG. 8, the first side wall 13 of the filter housing 10′ is detachably coupled with the surrounding wall 11′ for allowing the filter cartridge 20′ being replaceable supported in the filter housing 10′. Therefore, the first side wall 13′ of the filter housing 10′ forms a detachable cap having an outer threaded portion to detachably couple with an inner threaded portion of the surrounding wall 11′. In other words, the filter housing 10′ can be opened by detaching the first side wall 13′, so that the filter cartridge 20′ can be replaced and the filter compartment 14′ can be cleaned.

According to the preferred embodiment, the filter cartridge 20′ comprises a filter core 21′ having a water passage 212′ communicatively extended to the filtered water outlet 16′ for guiding the water passing from the water source to the first water opening 1′ in a filtered manner, and an unfiltering chamber 18′ communicating with the unfiltered water outlet 17′ and defining between an inner wall of the filter compartment 14′ and an outer wall of the filter core 21′ for directly guiding the water to the unfiltered water outlet 17′.

The filter core 21′, having an elongated tubular structure, comprises a tubular filtering wall 211′ defining the water passage 212′ therewithin and filtering elements 213′ provided at the filtering wall 211′ such that when the water passes through the filtering wall 211′, the water is filtered via the filtering elements 213′ to the water passage 212′ before exiting at the filtered water outlet 16′. Accordingly, the filtering elements 213′ are activated carbon and/or reverse osmosis membrane for filtering the unwanted substances in the water.

Accordingly, the water passage 212′ has a water exit 2122′ which is operatively linked to the filtered water outlet 16′ and is arranged in such a manner that when the water exit 2122′ is closed for blocking the water passing therethrough, the water can only flow to the unfiltered water outlet 17′ within the unfiltering chamber 18. Accordingly, the water entrance of the water passage is formed at the filtering wall 211′ for the water passing into the water passage 212′. When the water exit 2122′ is opened for allowing the water passing therethrough, the water is guided to flow to the unfiltered water outlet 17′. In other words, when the filtered water outlet 16′ is closed and the unfiltered water outlet 17′ is opened, the water from the water source will directly flow from the water inlet 15′ to the unfiltered water outlet 17′ through the unfiltering chamber 18′. Likewise, when the filtered water outlet 16′ is opened and the unfiltered water outlet 17′ is closed, the water from the water source will only penetrate through the filtering elements 213′ of the filter core 21′ into the water passage 212′, such that the water is filtered by the filtering elements 213′ before flowing out at the filtered water outlet 16′. Therefore, the water will first enter into the filter compartment 14′ to either stay at the unfiltering chamber 18′ to the unfiltered water outlet 17′ or penetrate through the filter core 21′ to the filtered water outlet 16′.

It is worth to mention that the filter core 21′ should have a length corresponding to a width of the filter housing 10′ such that the filter core 21′ is fittingly supported in the filter housing 10′. In addition, a diameter of the filter core 21′ should be smaller that a diameter of the filter housing 10′ to define the water passage 212′ within an inner circumferential wall of the filter core 21′ and the unfiltering chamber 18′ between the inner wall of the filter compartment 14′ and the outer circumferential wall of the filter core 21′.

As shown in FIGS. 7 and 8, the filter housing 10′ further comprises a cartridge holder for retaining the filter cartridge 20′ in position, wherein the cartridge holder comprises a first cartridge seat 191′ provided at the first side wall 13′ and a second cartridge seat 192′ which is provided at the second side wall 12′ and is coaxially aligned with the first cartridge seat 191′. Accordingly, two ends of the filter core 21′ is seated at the first and second cartridge seats 191′, 192′ respectively to alignedly support the filter core 21′ in the filter compartment 14′ along the center of the filter housing 10′.

The cartridge holder further comprises two sealing rings 193′, which are made of water sealing material such as rubber, disposed at the first and second cartridge seats 191′, 192′ to seal the ends of the filter core 21′ at the first and second side walls 13′, 12′ respectively so as to water-seal the clearances between the two ends of the filter core 21′ and the first and second side walls 13′, 12′ respectively. It is worth to mention that once the filter core 21′ is sealed at the filter housing 10′ via the sealing ring 193′, the water within the unfiltering chamber 18′ cannot enter into the water passage 212′ through the clearance so as to prevent any unfiltered water being exited at the filtered water outlet 17′. Therefore, in order to enter into the water passage 212′, the water must be penetrated through the filtering elements 213′ of the filter core 21′.

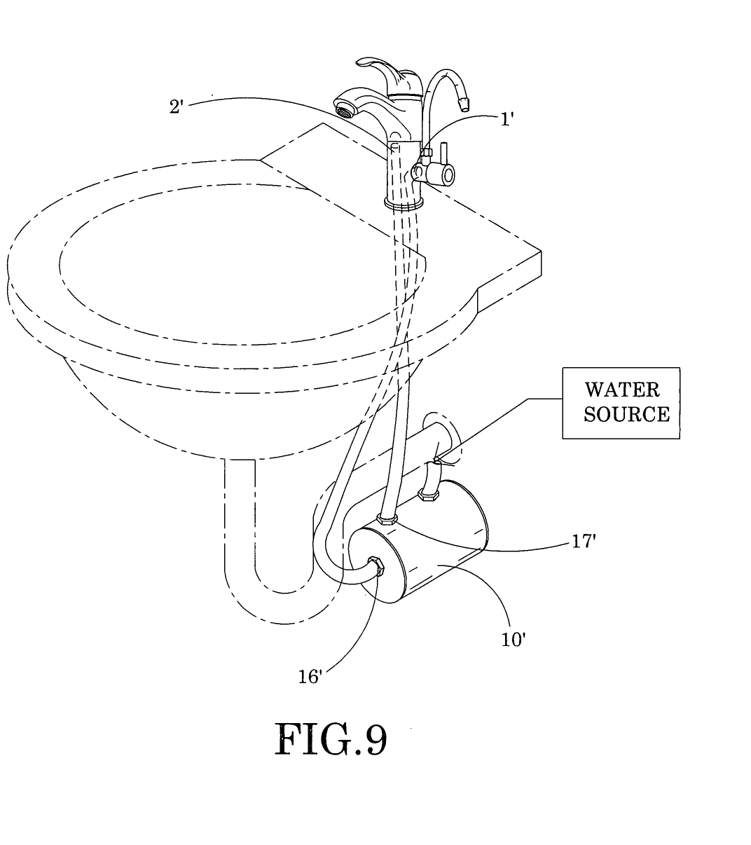

As shown in FIG. 9, the filtration faucet system of the present invention is connected to a faucet device to operatively control the filtration faucet system. Accordingly, the faucet device comprises a faucet body defining the first and second water openings 1′, 2′ and two control switches operatively controlling the first and second water openings 1, 2 in a selectively controllable manner. In other words, when the filtered water outlet 16′ and the unfiltered water outlet 17′ are operatively linking to the first and second water openings 1′, 2′ respectively, the water can be selected to be filtered and is guided to exit at the first water opening 1′ of the faucet body or can be selected to be unfiltered and is guided to exit at the second water opening 2′ of the faucet body. It is worth to mention that when the first control switch is switched to close the filtered water outlet 16′ while the second control switch is switch to open unfiltered water outlet 17′, the water from the water source will directly flow from the water inlet 15′ to the unfiltered water outlet 17′ through the unfiltering chamber 18′. When the first control switch is switched to open the filtered water outlet 16′ while the second control switch is switch to close unfiltered water outlet 17′, the water from the water source will only penetrate through the filtering elements 213′ of the filter core 21′ into the water passage 212′, such that the water is filtered by the filtering elements 213′ before flowing out at the filtered water outlet 16′. In addition, the faucet device as shown in FIG. 9 can also be incorporated with the filtration faucet system of the first embodiment.

It is worth to mention that the flexible water pipe 60 and the wall mount support 70 in the first embodiment can also incorporate with the filter housing 10′ of the second embodiment, wherein the flexible water pipe 60 is adapted for selectively adjusting a position of the filter housing 10′ with respect to the water source while the wall mount support 70 is adapted to securely mount the filter housing 10′ under the faucet countertop in a suspended manner.

The present invention can be applied for different level in a water supply system in a house. Accordingly, the filtration faucet system can be installed in a bathroom to filter the water for showering and a faucet to filter the water for brushing teeth. The filtration faucet system of the present invention can also installed to a toilet to filter the water for water cleansing jet and to unfilter the water for flushing.

In summary, the present invention is very flexible and convenient to be used. The filtration faucet system can be installed in different locations which is important for saving space and for decoration; it can be connected and disconnected with the exiting water system easily; it can have vary shapes, dimensions, and capacities for different locations and purposes; and the filter cartridge is easy to replace.

One skilled in the art will understand that the embodiment of the present invention as shown in the drawings and described above is exemplary only and not intended to be limiting.

It will thus be seen that the objects of the present invention have been fully and effectively accomplished. The embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A filtration faucet system for a faucet device having first and second water openings in selectively controllable manner, comprising:
a filter housing, which is adapted for mounting underneath a faucet countertop, having a filter compartment, a water inlet adapted for operatively linking to a water source, a filtered water outlet adapted for operatively linking to said first water opening of said faucet device, and an unfiltered water outlet adapted for operatively linking to said second water opening of said faucet device; and
a filter cartridge supported in said filter compartment of said filter housing, wherein said filter cartridge is adapted not only for filtering water flowing from said water inlet to said filtered water outlet before said water exits at said first water opening but also for guiding said water directly flowing from said water inlet to said unfiltered water outlet before said water exits at said second water opening, such that said filter cartridge is adapted for selectively filtering and unfiltering said water to said faucet device.

2. The filtration faucet system, as recited in claim 1, wherein said filter cartridge comprises a filter core having a water passage extended from said water inlet to said unfiltered water outlet for guiding said water passing from said water source to said second water opening in an unfiltered manner, and a filtering chamber communicating with said filtered water outlet and defining between an inner wall of said filter compartment and said filter core for filtering said water when said water passes through said filter core.

3. The filtration faucet system, as recited in claim 2, wherein said water passage has a water entrance operatively linked to said water inlet of said filter housing and a water exit which is operatively linked to said unfiltered water outlet and is arranged in such a manner that when said water exit is closed for blocking said water passing therethrough, said water is guided to pass through said filter core to said filtering chamber, when said water exit is opened for allowing said water passing therethrough, said water is guided to flow to said unfiltered water outlet.

4. The filtration faucet system, as recited in claim 2, wherein said filter core, having an elongated tubular structure, comprises a tubular filtering wall defining said water passage therewithin and filtering elements provided at said filtering wall such that when said water passes through said filtering wall, said water is filtered via said filtering elements to said filter chamber before exiting at said filtered water outlet.

5. The filtration faucet system, as recited in claim 3, wherein said filter core, having an elongated tubular structure, comprises a tubular filtering wall defining said water passage therewithin and filtering elements provided at said filtering wall such that when said water passes through said filtering wall, said water is filtered via said filtering elements to said filter chamber before exiting at said filtered water outlet.

6. The filtration faucet system, as recited in claim 1, wherein said water inlet is coaxially aligned with said unfiltered water outlet for guiding said water to directly flow from said water source to said second opening of said faucet device.

7. The filtration faucet system, as recited in claim 3, wherein said water inlet is coaxially aligned with said unfiltered water outlet for guiding said water to directly flow from said water source to said second opening of said faucet device.

8. The filtration faucet system, as recited in claim 5, wherein said water inlet is coaxially aligned with said unfiltered water outlet for guiding said water to directly flow from said water source to said second opening of said faucet device.

9. The filtration faucet system, as recited in claim 1, wherein said filter housing comprises a surrounding wall supporting said filtered water outlet thereat, a top wall supporting said unfiltered water outlet thereat, and a bottom wall supporting said water inlet thereat, wherein said filter compartment is defined within said surrounding wall, said top wall and said bottom wall.

10. The filtration faucet system, as recited in claim 5, wherein said filter housing comprises a surrounding wall supporting said filtered water outlet thereat, a top wall supporting said unfiltered water outlet thereat, and a bottom wall supporting said water inlet thereat, wherein said filter compartment is defined within said surrounding wall, said top wall and said bottom wall.

11. The filtration faucet system, as recited in claim 8, wherein said filter housing comprises a surrounding wall supporting said filtered water outlet thereat, a top wall supporting said unfiltered water outlet thereat, and a bottom wall supporting said water inlet thereat, wherein said filter compartment is defined within said surrounding wall, said top wall and said bottom wall.

12. The filtration faucet system, as recited in claim 9, wherein said top wall of said filter housing is detachably coupled with said surrounding wall for allowing said filter cartridge being replaceable supported in said filter housing.

13. The filtration faucet system, as recited in claim 11, wherein said top wall of said filter housing is detachably coupled with said surrounding wall for allowing said filter cartridge being replaceable supported in said filter housing.

14. The filtration faucet system, as recited in claim 11, wherein said filter housing further comprises a cartridge holder for retaining said filter cartridge in position, wherein said cartridge holder comprises a first cartridge seat provided at said top wall and a second cartridge seat which is provided at said bottom wall and is coaxially aligned with said first cartridge seat, wherein two ends of the filter core is seated at said first and second cartridge seats respectively to alignedly support said filter core in said filter compartment at a center of said surrounding wall.

15. The filtration faucet system, as recited in claim 13, wherein said filter housing further comprises a cartridge holder for retaining said filter cartridge in position, wherein said cartridge holder comprises a first cartridge seat provided at said top wall and a second cartridge seat which is provided at said bottom wall and is coaxially aligned with said first cartridge seat, wherein two ends of the filter core is seated at said first and second cartridge seats respectively to alignedly support said filter core in said filter compartment at a center of said surrounding wall.

16. The filtration faucet system, as recited in claim 1, wherein said filter cartridge comprises a filter core having a water passage extended to said filtered water outlet for guiding said water passing from said water source to said first water opening in a filtered manner, and an unfiltering chamber communicating with said unfiltered water outlet and defining between an inner wall of said filter compartment and said filter core for directly guiding said water to said unfiltered water outlet.

17. The filtration faucet system, as recited in claim 16, wherein said water passage has a water exit which is operatively linked to said filtered water outlet and is arranged in such a manner that when said water exit is closed for blocking said water passing therethrough, said water is guided to only flow to said unfiltered water outlet, when said water exit is opened for allowing said water passing therethrough, said water is guided to flow along said water passage to said filtered water outlet through said filter core.

18. The filtration faucet system, as recited in claim 17, wherein said filter core, having an elongated tubular structure, comprises a tubular filtering wall defining said water passage therewithin and filtering elements provided at said filtering wall such that when said water passes through said filtering wall, said water is filtered via said filtering elements to said water passage before exiting at said filtered water outlet.

19. The filtration faucet system, as recited in claim 18, wherein said filter housing comprises a surrounding wall supporting said water inlet and said unfiltered water outlet in a spaced apart manner, a first side wall supporting said filtered water outlet thereat, and an opposed second wall supporting said water inlet thereat, wherein said filter compartment is defined within said surrounding wall, said first side wall and said second side wall, wherein said water inlet and said unfiltered water outlet are positioned at the same orientation, wherein said water inlet is provided at said surrounding wall at a position close to said second side wall while said unfiltered water outlet is provided at said surrounding wall at a position close to said first side wall.

20. The filtration faucet system, as recited in claim 19, wherein said first side wall of said filter housing is detachably coupled with said surrounding wall for allowing said filter cartridge being replaceable supported in said filter housing.

21. The filtration faucet system, as recited in claim 20, wherein said filter housing further comprises a cartridge holder for retaining said filter cartridge in position, wherein said cartridge holder comprises a first cartridge seat provided at said first side wall and a second cartridge seat which is provided at said second side wall and is coaxially aligned with said first cartridge seat, wherein two ends of the filter core is seated at said first and second cartridge seats respectively to alignedly support said filter core in said filter compartment at a center of said surrounding wall.

22. The filtration faucet system, as recited in claim 21, wherein said cartridge holder further comprises two sealing rings disposed at said first and second cartridge seats to seal said ends of said filter core at said first and second side walls respectively.
